(19) United States
(12) Patent Application Publication
(10) Pub. No.: US 2026/0034720 A1
(43) Pub. Date: Feb. 5, 2026

(54) MULTI-COMPONENT MATERIAL FOR ORTHODONTIC APPLIANCES

(71) Applicant: Ormco Corporation, Brea, CA (US)

(72) Inventors: Wei WEI, Placentia, CA (US); Haibo QU, Walnut, CA (US)

(73) Assignee: Ormco Corporation, Brea, CA (US)

(21) Appl. No.: 19/356,520

(22) Filed: Oct. 13, 2025

Related U.S. Application Data
(63) Continuation of application No. PCT/US2024/024286, filed on Apr. 12, 2024.
(60) Provisional application No. 63/496,293, filed on Apr. 14, 2023.

(51) Int. Cl. B29C 51/14; A61C 7/08; B29C 37/00; B29C 51/00; B29K 67/00; B29K 75/00

(52) U.S. Cl. CPC B29C 51/14; A61C 7/08; B29C 37/005; B29C 51/002; B29K 2067/06; B29K 2075/00; B29K 2995/0018; B29K 2995/007; B29K 2995/0077; B29K 2995/0082; B29K 2995/0097

(57) ABSTRACT

A polymeric sheet includes a gradient repeating domain structure represented as -(A-AB₁-B-AB₂)ₙ-, -(A-AB-B)ₙ-, -(A-AB)ₙ-, -(AB)ₙ-, or -(AB₁-AB₂)ₙ- where A represents a domain region of component A, B represents a domain region of component B, and AB₁, AB₂, and AB each represent domain regions containing one or more mixtures of thermoplastic polymer A and thermoplastic polymer B. The polymeric sheet is configured as a dental appliance for positioning a patient's teeth.

### CROSS-REFERENCE TO RELATED APPLICATIONS

This application is a continuation of International Application No. PCT/US2024/024286, filed on Apr. 12, 2024, which claims the benefit of priority to U.S. Provisional Patent Application No. 63/496,293, filed on Apr. 14, 2023, the contents of which are incorporated herein by reference in their entirety.

### BACKGROUND

Orthodontic treatments involve repositioning misaligned teeth and improving bite configurations for improved cosmetic appearance and dental function. Repositioning teeth is accomplished by applying controlled forces to the teeth of a patient over an extended treatment time period.

Teeth may be repositioned by placing a dental or orthodontic appliance such as a polymeric incremental position adjustment appliance, generally referred to as an orthodontic aligner or an orthodontic aligner tray, over the teeth of the patient. The orthodontic alignment tray includes a polymeric shell with a plurality of cavities configured for receiving one or more teeth of the patient. The individual cavities in the polymeric shell are shaped to exert force on one or more teeth to resiliently and incrementally reposition selected teeth or groups of teeth in the upper or lower jaw. A series of orthodontic aligner trays are provided for wear by a patient sequentially and alternatingly during each stage of the orthodontic treatment to gradually reposition teeth from misaligned tooth arrangement to a successive more aligned tooth arrangement until a desired tooth alignment condition is ultimately achieved. Once the desired alignment condition is achieved, an aligner tray, or a series of aligner trays, may be used periodically or continuously in the mouth of the patient to maintain tooth alignment. In addition, orthodontic retainer trays may be used for an extended time period to maintain tooth alignment following the initial orthodontic treatment.

A stage of an orthodontic treatment may require that a polymeric orthodontic retainer or aligner tray remain in the mouth of the patient for up to 22 hours a day, over an extended treatment time period of days, weeks, months, or years.

### SUMMARY

The present application is directed to polymeric sheets configured as a dental appliance for positioning a patient's teeth.

In one aspect, a polymer sheet having a gradient structure is provided, the polymer sheet having the structure: -(A-AB₁-B-AB₂)ₙ-, where A represents a domain region of thermoplastic polymer A; B represents a domain region of thermoplastic polymer B; and AB₁ and AB₂ each represent domain regions containing one or more mixtures of thermoplastic polymer A and thermoplastic polymer B; when AB₁ represents more than a single mixture of thermoplastic polymer A and thermoplastic polymer B, a concentration gradient of decreasing A concentration and increasing B concentration is established in a direction within the sheet from A to B; when AB₂ represents more than a single mixture of thermoplastic polymer A and thermoplastic polymer B, a concentration gradient of increasing A concentration and decreasing B concentration is established in a direction from B to A; n represents an overall structural domain that repeats; and the polymer sheet is configured as a dental appliance for positioning a patient's teeth.

In one aspect, provided herein is a polymer sheet having a gradient repeating domain structure represented as: -(A-AB-B)ₙ-, where A represents a domain region of thermoplastic polymer A, B represents a domain region of thermoplastic polymer B, and AB represents a domain region containing one or more mixtures of thermoplastic polymer A and thermoplastic polymer B; when AB represents more than a single mixture of thermoplastic polymer A and thermoplastic polymer B, a concentration gradient of decreasing A concentration and increasing B concentration is established in a direction within the sheet from A to B and a concentration gradient of increasing A concentration and decreasing B concentration is established in a direction within the sheet from B to a subsequent A; n represents an overall structural domain that repeats; and the polymer sheet is configured as a dental appliance for positioning a patient's teeth.

In one aspect, provided herein is a polymer sheet having a gradient repeating domain structure represented as: -(A-AB)ₙ-, where A represents a domain region of thermoplastic polymer A; and AB represents a domain region containing one or more mixtures of thermoplastic polymer A and thermoplastic polymer B; when AB represents more than a single mixture of thermoplastic polymer A and thermoplastic polymer B, a concentration gradient of decreasing A concentration and increasing B concentration is established in a direction within the sheet from A rich to B rich and a concentration gradient of increasing A concentration and decreasing B concentration is established in a direction within the sheet from B rich to a subsequent less B rich. In some embodiments, n represents an overall composition that repeats. In some embodiments, the polymer sheet is configured as a dental appliance for positioning a patient's teeth.

In one aspect, provided herein is a polymer sheet having a gradient repeating domain structure represented as: -(AB)ₙ-, where AB represents a domain region containing one or more mixtures of thermoplastic polymer A and thermoplastic polymer B; when AB represents more than a single mixture of thermoplastic polymer A and thermoplastic polymer B, a concentration gradient of decreasing A concentration and increasing B concentration is established in a direction within the sheet from an A rich region to a B rich region and a concentration gradient of increasing A concentration and decreasing B concentration is established in a direction within the sheet from a B rich region to a subsequent A rich region (i.e., less B rich region); n represents an overall structural domain that repeats; and the polymer sheet is configured as a dental appliance for positioning a patient's teeth.

In one aspect, provided herein is a polymer sheet having a gradient repeating domain structure represented as: -(AB₁-AB₂)ₙ-, where AB₁ and AB₂ each represent domain regions containing one or more mixtures of thermoplastic polymer A and thermoplastic polymer B; when AB₁ represents more than a single mixture of thermoplastic polymer A and thermoplastic polymer B, a concentration gradient of decreasing A concentration and increasing B concentration is established in a direction within the sheet from A to B; when AB₂ represents more than a single mixture of thermoplastic polymer A and thermoplastic polymer B, a concentration gradient of increasing A concentration and decreasing B concentration is established in a direction from B to A; n represents an overall structural domain that repeats; and the polymer sheet is configured as a dental appliance for positioning a patient's teeth.

In one aspect, provided herein is a polymer sheet having a gradient structure: -(A-AB₁-B-AB₂)ₙ-; wherein A comprises 100% v/v of a thermoplastic polymer A, B comprises 100% v/v of a thermoplastic polymer B, and AB₁ and AB₂ each comprise a mixture of polymer A and polymer B; AB₁ comprises an amount of polymer A decreasing from 100% to 0% v/v, or to any range including and between any two of these values (e.g., from 100% to 20%, from 80% to 20%, or from 80% to 0%), and an amount of polymer B increasing from 0% to 100% v/v, or any range including and between any two of these values (e.g., from 0% to 80%, from 20% to 80%, or from 20% to 100%), and AB₂ comprises an amount of polymer B decreasing from 100% to 0%, or any range including and between any two of these values, and an amount of polymer A increasing from 0% to 100%, or any range including and between any two of these values; and n is from about 1 to about 10,000, or any range including and between any two of these values.

In some embodiments, a thickness of the gradient repeating domain structure is from about 0.15 microns to about 500 microns, or any range including and between any two of these values.

In some embodiments, thermoplastic polymer A and thermoplastic polymer B are each selected from the group consisting of a polyester, a co-polyester, a polycarbonate, a polyurethane, a polyamide, a polyolefin, a microcrystalline polyamide, a co-polyester of terephthalic acid, cyclohexane dimethanol, and 2,2,4,4-tetramethyl-1,3-cyclobutanediol, a co-polyester of terephthalic acid, ethylene glycol and diethylene glycol, an aromatic polyurethane based on MDI and hexanediol, an aromatic polyurethane with aliphatic diols, a co-polymer of propylene, ethylene and C4 to C8 alpha olefin, a cycloaliphatic polyamide, a (meth) acrylic polymer, a vinyl polymer such as polyvinyl chloride, a fluoropolymer, a polyurethane elastomer, an aromatic polyether polyurethane, a polyolefin elastomer, a polyester elastomer, a styrenic elastomer, a polyamide elastomer, a polyether polyamide (polypropylene oxide-based or polytetramethylene oxide-based), a cyclic olefin elastomer, an acrylic elastomer, an aromatic or aliphatic polyether, a polyester polyurethane, a siloxane elastomer, a polyether elastomer, a polyolefin elastomer, an olefin copolymer, a fluoroelastomer, and a mixture of any two or more thereof.

In some embodiments, thermoplastic polymer A has a different mechanical property from thermoplastic polymer B. In some embodiments, the mechanical property comprises hardness, rigidity, flexural strength, flexural modulus, Young's modulus, ductility, or tensile strength.

In some embodiments, thermoplastic polymer A and thermoplastic polymer B each have a flexural modulus of greater than about 35000 psi. In some embodiments, thermoplastic polymer A and thermoplastic polymer B each have a glass transition temperature from about 70° C. to about 150° C. In some embodiments, thermoplastic polymer A and thermoplastic polymer B each have a hardness from about A50 to D85. In some embodiments, thermoplastic polymer A and thermoplastic polymer B each have a light transmittance between 400 nm and 800 nm of greater than about 75%. In some embodiments, thermoplastic polymer A and thermoplastic polymer B each have an elongation at break of greater than about 70%. In some embodiments, thermoplastic polymer A and thermoplastic polymer B each have a tensile strength of greater than about 4000 psi.

In another aspect, provided is a dental appliance for positioning a patient's teeth, the dental appliance comprising any one of the polymeric sheets described herein, wherein the polymeric sheet comprises a plurality of cavities configured to receive a patient's teeth, and wherein the polymeric sheet is configured to apply a resilient positioning force to the patient's teeth.

In some embodiments, the dental appliance has a thickness from about 0.3 mm to about 1 mm, or any range including and between any two of these values.

In some embodiments, the dental appliance is removable.

In another aspect, provided is a method of making a dental appliance for positioning a patient's teeth, the method comprising: providing a positive model of the patient's teeth in a target position; and thermoforming any one of the polymeric sheets described herein over the positive model to make the dental appliance.

In another aspect, provided is a method of moving a patient's teeth from an initial configuration to a target configuration, the method comprising: placing a dental appliance onto the patient's teeth, the dental appliance comprising any one of the polymeric sheets described herein, wherein the polymeric sheet comprises a plurality of cavities configured to receive the patient's teeth, wherein the plurality of cavities is arranged to be in the target configuration; and wherein the dental appliance applies a resilient positioning force to the patient's teeth for a period of time, thereby moving the teeth from the initial configuration towards the target configuration.

In some embodiments, the dental appliance is removable.

In some embodiments, the period of time is from 1 day to 14 days.

### BRIEF DESCRIPTION OF THE DRAWINGS

FIG. 1 depicts an illustrative embodiment of the multi-component polymer sheet exhibiting a gradient repeating structure represented as formula -(A-AB₁-B-AB₂)ₙ-.

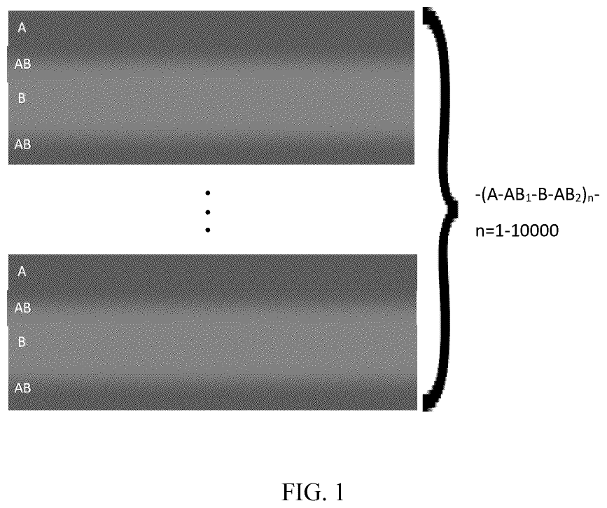

FIG. 2 depicts another illustrative embodiment of the multi-component polymer sheet exhibiting a gradient repeating structure represented as formula -(AB₁-AB₂)ₙ-.

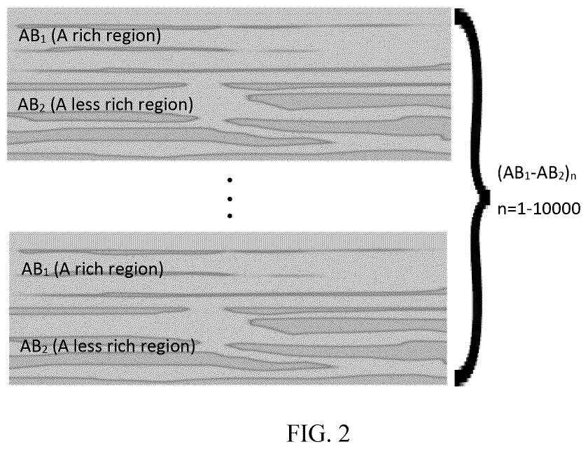

### DETAILED DESCRIPTION

The present application is directed to polymeric sheets configured as dental appliances for positioning a patient's teeth.

### Definitions

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “and” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or illustrative language (e.g., “such as”) provided herein, is intended merely to better illuminate the embodiments and does not pose a limitation on the scope of the claims unless otherwise stated. No language in the specification should be construed as indicating any non-claimed element as essential.

The term “dental appliance” or “orthodontic appliance” is used herein with reference to any device placed in or on the teeth of a subject. Dental appliances include but are not limited to orthodontic (e.g., dental or orthodontic aligners that reposition a patient's teeth), prosthetic, retaining (e.g., a retainer), snoring/airway, cosmetic, therapeutic, protective (e.g., mouth guards) and habit-modification devices.

The term “flexural modulus” is used herein with reference to the rigidity of a material and/or resistance of the material to deformation in bending. The higher the flexural modulus of the material, the more resistant to bending it is. For an isotropic material the elastic modulus measured in any direction is the same.

The term “hardness” is used herein with reference to a Shore hardness scale, and unless otherwise stated is measured according to ASTM D 2240. A durometer measures the penetration of a metal foot or pin into the surface of a material. There are different durometer scales, but Shore A and Shore D are commonly used. Materials with higher durometer values will be harder compared to materials with a lower durometer value. Shore hardness and modulus are generally correlated and can be converted by approximation if only one value is known by methods described in the art.

The expressions “modulus,” “Young's modulus” and “elastic modulus” are used herein with reference to the rigidity of a material and/or resistance of the material to stretching. The higher the modulus of the material, the more rigid. The flexural modulus and elastic modulus of a material may be the same or different. For isotropic materials such as A, B and C, flexural modulus and modulus (which may also be referred to as elastic modulus) are substantially the same and one or the other may be measured dependent upon the circumstances. For polymers, the mechanical properties including elastic modulus and other properties may be measured as proscribed by ASTM D 638. Flexural modulus may be measured by the test listed in ASTM D790), and uses units of force per area. Unless designated otherwise, “modulus” refers to elastic modulus.

The term “thermoplastic polymer” is used herein with reference to a polymer is a polymer that becomes pliable or moldable above a specific temperature and solidifies upon cooling, provided that the heat and pressure do not chemically decompose the polymer.

### Multi-Component Polymer Sheets

In some embodiments, the polymeric sheet comprises a gradient repeating domain structure represented as: -(A-AB₁-B-AB₂)ₙ-, -(A-AB-B)ₙ-, -(A-AB)ₙ-, -(AB)ₙ-, or -(AB₁-AB₂)ₙ- where A represents a domain region of thermoplastic polymer A; B represents a domain region of thermoplastic polymer B; and AB₁, AB₂, and AB each represent domain regions containing one or more mixtures of thermoplastic polymer A and thermoplastic polymer B. In some embodiments, n represents an overall structural domain that repeats. In some embodiments, the polymer sheet is configured as a dental appliance for positioning a patient's teeth.

In some embodiments, when the gradient repeating domain structure is represented as -(A-AB₁-B-AB₂)ₙ-, when AB₁ represents more than a single mixture of thermoplastic polymer A and thermoplastic polymer B, a concentration gradient of decreasing A concentration and increasing B concentration is established in a direction within the sheet from A to B, and when AB₂ represents more than a single mixture of thermoplastic polymer A and thermoplastic polymer B, a concentration gradient of increasing A concentration and decreasing B concentration is established in a direction from B to A.

In some embodiments, when the gradient repeating domain structure is represented as -(A-AB-B)ₙ-, when AB represents more than a single mixture of thermoplastic polymer A and thermoplastic polymer B, a concentration gradient of decreasing A concentration and increasing B concentration is established in a direction within the sheet from A to B and a concentration gradient of increasing A concentration and decreasing B concentration is established in a direction within the sheet from B to a subsequent A.

In some embodiments, when the gradient repeating domain structure is represented as -(A-AB)ₙ-, when AB represents more than a single mixture of thermoplastic polymer A and thermoplastic polymer B, a concentration gradient of decreasing A concentration and increasing B concentration is established in a direction within the sheet from A to B and a concentration gradient of increasing A concentration and decreasing B concentration is established in a direction within the sheet from B to a subsequent A.

In some embodiments, when the gradient repeating domain structure is represented as -(AB)ₙ-, when AB represents more than a single mixture of thermoplastic polymer A and thermoplastic polymer B, a concentration gradient of decreasing A concentration and increasing B concentration is established in a direction within the sheet from an A rich region to a B rich region and a concentration gradient of increasing A concentration and decreasing B concentration is established in a direction within the sheet from a B rich region to a subsequent A rich region.

In some embodiments, when the gradient repeating domain structure is represented as -(AB₁-AB₂)ₙ-, when AB₁ represents more than a single mixture of thermoplastic polymer A and thermoplastic polymer B, a concentration gradient of decreasing A concentration and increasing B concentration is established in a direction within the sheet from A to B, and when AB₂ represents more than a single mixture of thermoplastic polymer A and thermoplastic polymer B, a concentration gradient of increasing A concentration and decreasing B concentration is established in a direction from B to A.

In some embodiments, when the repeating domain structure is represented as -(A-AB₁-B-AB₂)ₙ-, A comprises 100% v/v of a thermoplastic polymer A, B comprises 100% v/v of a thermoplastic polymer B, and AB₁ and AB₂ each comprise a mixture of polymer A and polymer B, wherein AB₁ comprises an amount of polymer A decreasing from 100% to 0% v/v, or any range including and between any two of these values, and an amount of polymer B increasing from 0% to 100% v/v, or any range including and between any two of these values, and AB₂ comprises an amount of polymer B decreasing from 100% to 0%, or any range including and between any two of these values, and an amount of polymer A increasing from 0% to 100% or any range including and between any two of these values. While the decrease from 100% or increase from 0% are used at the extremes to show the direction of the gradient, the starting point for the decrease does not need to be 100%, nor the starting point for the increase does not need to be 0%. There will be blending of regions at the interface of the A, AB, and B regions of the structure where the maximum amount of A or B is something less than 100% such that the gradients may not reach the 100% or 0% value, but the extrapolated trend of the gradient would be in that direction.

In some embodiments, when AB, AB₁, or AB₂ represents more than a single mixture of thermoplastic polymer A and thermoplastic polymer B, AB, AB₁, or AB₂ comprises a random mixture of thermoplastic polymer A and thermoplastic polymer B.

In some embodiments, n represents an overall structural domain that repeats. In some embodiments, n is a number that ranges from about 1 to about 10000, or any range including and between any two of these values. In some embodiments, n is about 1, about 100, about 200, about 300, about 400, about 500, about 600, about 700, about 800, about 900, about 1000, about 2000, about 3000, about 4000, about 5000, about 6000, about 7000, about 8000, about 9000, or about 10000. In some embodiments, n is the same for each domain structure in the repeating domain structure. In some embodiments, n may be different for each domain structure in the repeating domain structure.

In some embodiments, a thickness of -(A-AB₁-B-AB₂)ₙ-, -(A-AB-B)ₙ-, -(A-AB)ₙ-, or -(AB)ₙ- is from about 0.15 microns to about 500 microns, or any range including and between any two of these values. In some embodiments, a thickness of -(A-AB₁-B-AB₂)ₙ-, -(A-AB-B)ₙ-, -(A-AB)ₙ-, or -(AB)ₙ- is about 0.15 microns, about 0.5 microns, about 1 micron, about 50 microns, about 100 microns, about 200 microns, about 300 microns, about 400 microns, or about 500 microns.

The thermoplastic polymer A may have a different mechanical property from thermoplastic polymer B. Non-limiting examples of the mechanical property comprises hardness, rigidity, flexural strength, flexural modulus, Young's modulus, ductility, or tensile strength.

The thermoplastic polymer A includes a single thermoplastic polymer. In some embodiments, thermoplastic polymer A includes a mixture of two or more thermoplastic polymers. The thermoplastic polymer B may include a single thermoplastic polymer. In some embodiments, thermoplastic polymer B includes a mixture of two or more thermoplastic polymers.

In some embodiments, thermoplastic polymer A and thermoplastic polymer B may each be a single or a mixture of one or more embodiments. While the formulas provided herein express domain regions of thermoplastic polymer A, domain regions of thermoplastic polymer B, and mixtures of domain regions of thermoplastic polymer A and domain regions of thermoplastic polymer B as AB₁, AB₂, and AB, these formulas do not exclude the potential to include one or more domain regions comprising additional thermoplastic polymers that are different from thermoplastic polymer A and thermoplastic polymer B. For example, a “C” thermoplastic polymer may be included, resulting in BC-C, BC₁-C, C, C-D, etc. type regions in addition to the illustrative A/B system(s) disclosed herein.

Suitable thermoplastic polymers for use in the polymeric sheets described herein include a polyester, a co-polyester, a polycarbonate, a polyurethane, a polyamide, a polyolefin, a microcrystalline polyamide, a co-polyester of terephthalic acid, cyclohexane dimethanol, and 2,2,4,4-tetramethyl-1,3-cyclobutanediol, a co-polyester of terephthalic acid, ethylene glycol and diethylene glycol, an aromatic polyurethane based on MDI and hexanediol, an aromatic polyurethane with aliphatic diols, a co-polymer of propylene, ethylene and C4 to C8 alpha olefin, a cycloaliphatic polyamide, a (meth) acrylic polymer, a vinyl polymer such as polyvinyl chloride, or a fluoropolymer, a polyurethane elastomer, an aromatic polyether polyurethane, a polyolefin elastomer, a polyester elastomer, a styrenic elastomer, a polyamide elastomer, a polyether polyamide (polypropylene oxide-based or polytetramethylene oxide-based), a cyclic olefin elastomer, an acrylic elastomer, an aromatic or aliphatic polyether, a polyester polyurethane, a siloxane elastomer, a polyether elastomer, a polyolefin elastomer, an olefin copolymer, a fluoroelastomer, or a mixture of any two or more thereof.

In some embodiments, each of the thermoplastic polymers A and B have a flexural modulus of greater than about 35000 psi. In some embodiments, each of the thermoplastic polymers A and B have a glass transition temperature from about 70° C. to about 150° C. In some embodiments, each of the thermoplastic polymers A and B have a hardness from about A50 to D85. In some embodiments, each of the thermoplastic polymers A and B have a light transmittance from about 75% to 100%. In some embodiments, each of the thermoplastic polymers A and B have an elongation at break from about 70% to 600%. In some embodiments, each of the thermoplastic polymers A and B have a tensile strength from about 4000 psi to 8000 psi.

### Dental Appliance

Provided are dental appliances for positioning a patient's teeth.

In some embodiments, the dental appliance comprises a polymer sheet having a gradient repeating domain structure: -(A-AB₁-B-AB₂)ₙ-, wherein A represents a domain region of thermoplastic polymer A; B represents a domain region of thermoplastic polymer B; AB₁ and AB₂ each represent domain regions containing one or more mixtures of thermoplastic polymer A and thermoplastic polymer B; when AB₁ represents more than a single mixture of thermoplastic polymer A and thermoplastic polymer B, a concentration gradient of decreasing A concentration and increasing B concentration is established in a direction within the sheet from A to B; when AB₂ represents more than a single mixture of thermoplastic polymer A and thermoplastic polymer B, a concentration gradient of increasing A concentration and decreasing B concentration is established in a direction from B to A; and n represents an overall structural domain that repeats.

In some embodiments, the dental appliance comprises a polymer sheet having a gradient repeating domain structure: -(A-AB₁-B-AB₂)ₙ- wherein A comprises 100% v/v of a thermoplastic polymer A, B comprises 100% v/v of a thermoplastic polymer B, and AB₁ and AB₂ each comprise a mixture of polymer A and polymer B, wherein AB₁ comprises an amount of polymer A decreasing from 100% to 0% v/v, or any range including and between any two of these values, and an amount of polymer B increasing from 0% to 100% v/v, or any range including and between any two of these values, and AB₂ comprises an amount of polymer B decreasing from 100% to 0%, or any range including and between any two of these values, and an amount of polymer A increasing from 0% to 100%, or any range including and between any two of these values; and wherein n is from about 1 to about 10,000.

In some embodiments, the dental appliance comprises a polymer sheet having a gradient repeating domain structure: -(A-AB-B)ₙ-, wherein A represents a domain region of thermoplastic polymer A; B represents a domain region of thermoplastic polymer B; AB represents a domain region containing one or more mixtures of thermoplastic polymer A and thermoplastic polymer B; when AB represents more than a single mixture of thermoplastic polymer A and thermoplastic polymer B, a concentration gradient of decreasing A concentration and increasing B concentration is established in a direction within the sheet from A to B and a concentration gradient of increasing A concentration and decreasing B concentration is established in a direction within the sheet from B to a subsequent A; and n represents an overall structural domain that repeats.

In some embodiments, the dental appliance comprises a polymer sheet having a gradient repeating domain structure: -(A-AB)ₙ-, wherein A represents a domain region of thermoplastic polymer A; AB represents a domain region containing one or more mixtures of thermoplastic polymer A and thermoplastic polymer B; when AB represents more than a single mixture of thermoplastic polymer A and thermoplastic polymer B, a concentration gradient of decreasing A concentration and increasing B concentration is established in a direction within the sheet from A to B and a concentration gradient of increasing A concentration and decreasing B concentration is established in a direction within the sheet from B to a subsequent A; and n represents an overall structural domain that repeats.

In some embodiments, the dental appliance comprises a polymer sheet having a gradient repeating domain structure: -(AB)ₙ-, wherein AB represents a domain region containing one or more mixtures of thermoplastic polymer A and thermoplastic polymer B; when AB represents more than a single mixture of thermoplastic polymer A and thermoplastic polymer B, a concentration gradient of decreasing A concentration and increasing B concentration is established in a direction within the sheet from an A rich region to a B rich region and a concentration gradient of increasing A concentration and decreasing B concentration is established in a direction within the sheet from a B rich region to a subsequent A rich region; and n represents an overall structural domain that repeats.

In some embodiments, the dental appliance comprises a polymer sheet having a gradient repeating domain structure: -(AB₁-AB₂)ₙ-, wherein AB₁ and AB₂ each represent domain regions containing one or more mixtures of thermoplastic polymer A and thermoplastic polymer B; when AB₁ represents more than a single mixture of thermoplastic polymer A and thermoplastic polymer B, a concentration gradient of decreasing A concentration and increasing B concentration is established in a direction within the sheet from A to B; when AB₂ represents more than a single mixture of thermoplastic polymer A and thermoplastic polymer B, a concentration gradient of increasing A concentration and decreasing B concentration is established in a direction from B to A; and n represents an overall structural domain that repeats.

In any of the embodiments described herein, the polymer sheet of the dental appliance comprises a plurality of cavities configured to receive a patient's teeth, and the polymeric sheet is configured to apply a resilient positioning force to the patient's teeth.

In some embodiments, the dental appliance has a thickness from about 0.3 mm to about 1 mm, or any range including and between any two of these values. In some embodiments, the dental appliance has a thickness of about 0.3 mm, about 0.4 mm, about 0.5 mm, about 0.6 mm, about 0.7 mm, about 0.8 mm, about 0.9 mm, or about 1 mm. In some embodiments, the present invention provides a dental appliance for positioning a patient's teeth. In some embodiments, the dental appliance is removable.

The dental appliances described herein may be used, for example, as dental aligners to reposition a patient's teeth from an initial configuration to a target configuration (e.g., in a configuration where the patient's teeth are in proper alignment), as a retainer to maintain a patient's teeth in a target configuration, or as a mouth guard.

In another embodiment, the present invention provides an orthodontic system for positioning a patient's teeth from an initial configuration to a target configuration. The orthodontic system can include a plurality of dental appliances, each dental appliance comprising any one of the polymeric sheets described herein, the polymeric sheet having teeth receiving cavities shaped to directly receive at least some of the patient's teeth and being configured to apply a resilient positioning force to the patient's teeth. Each dental appliance comprises an incremental adjustment to the position of one or more of the patient's teeth compared to the initial configuration of patient's teeth, wherein each dental appliance is successively worn by the patient to move their teeth from the initial configuration to a successive configuration until the target configuration is achieved.

Provided are methods of making a dental appliance for positioning a patient's teeth, the method comprising providing a positive model of the patient's teeth in a target position and thermoforming a polymeric sheet as described herein over the positive model to make the dental appliance.

### Methods of Positioning a Patient's Teeth

Provided are methods of moving a patient's teeth from an initial configuration to a target configuration, the method comprising: placing a dental appliance onto the patient's teeth, the dental appliance comprising any one of the polymeric sheets described herein, wherein the polymeric sheet comprises a plurality of cavities configured to receive the patient's teeth, wherein the plurality of cavities is arranged to be in the target configuration; wherein the dental appliance applies a resilient positioning force to the patient's teeth for a period of time, thereby moving the teeth from the initial configuration towards the target configuration.

In some embodiments, the method comprises: providing a patient with an orthodontic system for positioning the patient's teeth from an initial configuration to a target configuration, the orthodontic system comprising a plurality of dental appliances, each dental appliance comprising any one of the polymeric sheets described herein, the polymeric sheet having teeth receiving cavities shaped to directly receive the patient's teeth and being configured to apply a resilient positioning force to the patient's teeth. Each dental appliance comprises an incremental adjustment to the position of one or more of the patient's teeth compared to the initial configuration of patient's teeth, wherein each dental appliance is successively worn by the patient for a period of time to move their teeth from the initial configuration to a successive configuration until the target configuration is achieved.

In some embodiments, the dental appliance is removable.

In some embodiments, the period of time the patient wears each individual dental appliance is from 1 day to 14 days. In some embodiments, the period of time the patient wears each individual dental appliance is 1 day, 2 days, 3 days, 4 days, 5 days, 6 days, 7 days, 8 days, 9 days, 10 days, 11 days, 12 days, 13 days, or 14 days. In some embodiments, the period of time the patient wears each individual dental appliance is the same for each individual dental appliance. In some embodiments, the period of time the patient wears each individual dental appliance is difference for each individual dental appliance.

The orthodontic system may be used for any period of time required to achieve the target configuration. Non-limiting examples include from 1 week to 3 weeks, 1 month to 12 months, 1 year to 3 years, or any period of time required until the target configuration is achieved.

### EXAMPLES

The following examples more specifically illustrate the multi-component polymer film according to various embodiments described above. These examples should in no way be construed as limiting the scope of the present technology.

### Example 1: Preparation of the Multi-Component Polymer Film

### (PETG-PETG/TPU)ₙ

Multi-component co-extrusion is used to produce a polymer film comprising polyethylene terephthalate glycol (PETG, S2008, SK Chemicals Co., Korea) and thermoplastic polyurethane (TPU, Texin RxT50D, Covestro, Pittsburgh, PA), (PETG-PETG/TPU)ₙ. Co-extrusion is conducted with a PETG melt temperature of 240-270° C. and a PETG/TPU mixture melt temperature of 230-260° C. to ensure matching viscosities and to maximize polymer film and domain region quality. The PETG/TPU mixture is produced by mixing the PETG and TPU with a volume ratio of 1.0. Polymer films extruded through an 8-inch sheet die are wound into a roll. Polymer films consist of 512 domain regions by repeating the PETG-PETG/TPU unit 256 times. The produced polymer film thicknesses is set at 0.75 mm, with a thickness of each domain region being 1.5 microns.

(PCTG/TPU₁-PCTG/TPU₂)ₙ

Multi-component co-extrusion is used to produce a polymer film comprising polycyclohexylenedimethylene terephthalate glycol (PCTG, MP100, Eastman, Kingsport, TN), and thermoplastic polyurethane (TPU, Texin RxT50D, Covestro, Pittsburgh, PA), (PCTG/TPU₁-PCTG/TPU₂)ₙ. Co-extrusion is conducted at a temperature of 260-280° C. to ensure matching viscosities between MP100 and Texin RxT50D and to maximize film quality. The PCTG/TPU₁ mixture is produced by mixing the MP100 and Texin RxT50D with a volume ratio of 4:1. The PCTG/TPU₂ mixture is produced by mixing the MP100 and Texin RxT50D with a volume ratio of 1:4. Films extruded through an 8-inch sheet die are wound into a roll. Polymer films consist of 512 domain regions by repeating PCTG/TPU₁-PCTG/TPU₂ unit 256 times. The produced polymer film thicknesses is set at 0.75 mm, with a thickness of each domain region being 1.5 microns.

### Example 2: Preparation of the Dental Appliance

The polymer film is subsequently thermal formed into a dental appliance. A Biostar® thermal forming machine is used to convert the polymer film into the dental appliance with a thermal forming temperature of 190° C. and heating time of 40 seconds.

While certain embodiments have been illustrated and described, it should be understood that changes and modifications can be made therein in accordance with ordinary skill in the art without departing from the technology in its broader aspects.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A polymer sheet having a gradient repeating domain structure:
-(A-AB₁-B-AB₂)ₙ-
wherein:
A represents a domain region of thermoplastic polymer A;
B represents a domain region of thermoplastic polymer B;
AB₁ and AB₂ each represent domain regions containing one or more mixtures of thermoplastic polymer A and thermoplastic polymer B;
when AB₁ represents more than a single mixture of thermoplastic polymer A and thermoplastic polymer B, a concentration gradient of decreasing A concentration and increasing B concentration is established in a direction within the sheet from A to B;
when AB₂ represents more than a single mixture of thermoplastic polymer A and thermoplastic polymer B, a concentration gradient of increasing A concentration and decreasing B concentration is established in a direction from B to A;
n represents an overall structural domain that repeats; and
the polymer sheet is configured as a dental appliance for positioning a patient's teeth.

2. A polymer sheet having a gradient repeating domain structure represented as:
-(A-AB-B)ₙ-
wherein:
A represents a domain region of thermoplastic polymer A;
B represents a domain region of thermoplastic polymer B;
AB represents a domain region containing one or more mixtures of thermoplastic polymer A and thermoplastic polymer B;
when AB represents more than a single mixture of thermoplastic polymer A and thermoplastic polymer B, a concentration gradient of decreasing A concentration and increasing B concentration is established in a direction within the sheet from A to B and a concentration gradient of increasing A concentration and decreasing B concentration is established in a direction within the sheet from B to a subsequent A;
n represents an overall structural domain that repeats; and
the polymer sheet is configured as a dental appliance for positioning a patient's teeth.

3. A polymer sheet having a gradient repeating domain structure represented as:
-(A-AB)ₙ-
wherein:
A represents a domain region of thermoplastic polymer A;
AB represents a domain region containing one or more mixtures of thermoplastic polymer A and thermoplastic polymer B;
when AB represents more than a single mixture of thermoplastic polymer A and thermoplastic polymer B, a concentration gradient of decreasing A concentration and increasing B concentration is established in a direction within the sheet from an A rich region to a B rich region and a concentration gradient of increasing A concentration and decreasing B concentration is established in a direction within the sheet from a B rich region to a subsequent A rich region;
n represents an overall structural domain that repeats; and
the polymer sheet is configured as a dental appliance for positioning a patient's teeth.

4. The polymer sheet of claim 1, wherein a thickness of the gradient repeating domain structure is from about 0.15 microns to about 500 microns.

5. The polymer sheet of claim 1, wherein thermoplastic polymer A and thermoplastic polymer B are each selected from the group consisting of: a polyester, a co-polyester, a polycarbonate, a polyurethane, a polyamide, a polyolefin, a microcrystalline polyamide, a co-polyester of terephthalic acid, cyclohexane dimethanol, and 2,2,4,4-tetramethyl-1,3-cyclobutanediol, a co-polyester of terephthalic acid, ethylene glycol and diethylene glycol, an aromatic polyurethane based on MDI and hexanediol, an aromatic polyurethane with aliphatic diols, a co-polymer of propylene, ethylene and C4 to C8 alpha olefin, a cycloaliphatic polyamide, a (meth) acrylic polymer, a vinyl polymer such a polyvinyl chloride, a fluoropolymer, a polyurethane elastomer, an aromatic polyether polyurethane, a polyolefin elastomer, a polyester elastomer, a styrenic elastomer, a polyamide elastomer, a polyether polyamide (polypropylene oxide-based or polytetramethylene oxide-based), a cyclic olefin elastomer, an acrylic elastomer, an aromatic or aliphatic polyether, a polyester polyurethane, a siloxane elastomer, a polyether elastomer, a polyolefin elastomer, an olefin copolymer, a fluoroelastomer, and a mixture of any two or more thereof.

6. The polymer sheet of claim 1, wherein thermoplastic polymer A has a different mechanical property from thermoplastic polymer B.

7. The polymer sheet of claim 6, wherein the mechanical property comprises: hardness, rigidity, flexural strength, flexural modulus, Young's modulus, ductility, or tensile strength.

8. The polymer sheet of claim 1, wherein thermoplastic polymer A and thermoplastic polymer B each have a flexural modulus of greater than about 35000 psi.

9. The polymer sheet of claim 1, wherein polymer A and polymer B each have a glass transition temperature from about 70° C. to about 150° C.

10. The polymer sheet of claim 1, wherein thermoplastic polymer A and thermoplastic polymer B each have a hardness from about A50 to D85.

11. The polymer sheet of claim 1, wherein thermoplastic polymer A and thermoplastic polymer B each have a light transmittance between 400 nm and 800 nm of greater than about 75%.

12. The polymer sheet of claim 1, wherein thermoplastic polymer A and thermoplastic polymer B each have an elongation at break of greater than about 70%.

13. The polymer sheet of claim 1, wherein thermoplastic polymer A and thermoplastic polymer B each have a tensile strength of greater than about 4000 psi.

14. A dental appliance for positioning a patient's teeth comprising the polymeric sheet of claim 1, wherein the polymeric sheet comprises a plurality of cavities configured to receive a patient's teeth, and wherein the polymeric sheet is configured to apply a resilient positioning force to the patient's teeth.

15. The dental appliance of claim 14, having a thickness from about 0.3 mm to about 1 mm.

16. The dental appliance of claim 14, wherein the dental appliance is removable.

17. A method of making a dental appliance for positioning a patient's teeth, the method comprising:
providing a positive model of the patient's teeth in a target position; and
thermoforming the polymer sheet of claim 1 over the positive model to make the dental appliance.

18. A method of moving a patient's teeth from an initial configuration to a target configuration, the method comprising:
placing a dental appliance onto the patient's teeth, the dental appliance comprising the polymeric sheet of claim 1, wherein the polymeric sheet comprises a plurality of cavities configured to receive the patient's teeth, wherein the plurality of cavities is arranged to be in the target configuration;
wherein the dental appliance applies a resilient positioning force to the patient's teeth for a period of time, thereby moving the teeth from the initial configuration towards the target configuration.

19. The method of claim 18, wherein the dental appliance is removable.

20. The method of claim 18, wherein the period of time is from 1 day to 14 days.
